(19) United States
(12) Patent Application Publication
(10) Pub. No.: US 2005/0018769 A1
(43) Pub. Date: Jan. 27, 2005

(54) Transcoder-free operation in mobile communication system

(76) Inventors: Karl Hellwig, Wonfurt (DE); Emilian Ertel, Nuernberg (DE); Rudolf Hofmann, Forchheim (DE)

Correspondence Address: ERICSSON INC., 6300 LEGACY DRIVE, M/S EVR C11, PLANO, TX, 75024, US

(21) Appl. No.: 10/500,085

(22) PCT Filed: Dec. 27, 2001
(86) PCT No.: PCT/EP01/15315

(51) Int. Cl. H04N 7/12

(52) U.S. Cl. 375/240.12

(57) ABSTRACT

The present invention relates to an improved transcoding apparatus (1) for use in a switching network of a telecommunication system, said transcoding apparatus (1) including a) a plurality of transcoding units for source encoding and decoding data, for example speech data, wherein at least one transcoding unit (11) of said plurality is capable of operating in tandem-free operation mode, b) switching means (12) adapted to switch data through said plurality of transcoding units, c) a transcoder controller (13) for controlling said switching means (12) and said plurality of trnascoding units, wherein said transcoder controller (13) is adapted to d) instruct said switching means (12) to insert one of said at least one transcoding unit (11) into a data path associated with a connection between a mobile terminal of said telecommunicaiton system and said switching network, and wherein said transcoder controller (13) is adapted to e) instruct said one of said at least one transcoding unit (11) to operate in tandem-free operation mode, and wherein said transcoder controller (13) is adapted to f) instuct, during said connection, said switching means to eliminate said one of said at least one transcoding unit from said data path.

### FIELD OF THE INVENTION

The present invention relates to digital telecommunication systems, and in particular to a transcoder-free operation in mobile communication systems.

### DESCRIPTION OF THE PRIOR ART

One existing telecommunications system is the Global System for Mobile Communications (GSM) which provides a user with a mobile telephone with access to other mobile telephones and the public switched telephone network (PSTN).

In a GSM network, a part of which is schematically illustrated in FIG. 3, a mobile terminal (mobile station, MS) communicates with a base transceiver station (BTS) which provides and manages the air interface between the mobile terminal (MS) and the GSM network switching sub-systems. The data, for example speech data, received from the mobile terminal during a connection (a call, e.g.) is passed by a BTS and a base station controller (BSC) to a mobile switching centre (MSC) by way of a transcoding unit (TRAU), the operation of which will be explained later. The mobile switching centre (MSC) includes a group switch and a switching controller (not shown in FIG. 3) which controls the routing of the speech data received from the mobile terminal (MS) to another MSC via the inter-MSC E-interface, to the PSTN or to another BSC connected to that MSC. Typically, an MSC is connected to a number of base station controllers (BSC) which are in turn connected to a number of base transceiver stations (BTS) providing coverage for a large number of mobile terminals (MS).

As mentioned above, and as is well known, the mobile switching centre (MSC) has a group switch for switching signals, and a switching controller which controls the group switch to switch data (speech data, e.g.) associated with connections (calls, e.g.) through the MSC. The switching controller controls the switching/routing of the connection through the group switch and for most connections the switching controller does not alter the data switched through the group switch. In this situation, the mobile switching centre is said to be “transparently” through-connecting the data path associated to the connection.

However, in some situations the switching controller adds supplementary services to the connection data (speech data, e.g.). When supplementary services are added, the (data path associated to the) connection is no longer transparently connected through the MSC group switch. The term “supplementary services” is used herein to indicate that the connection is not switched transparently through the mobile switching centre (MSC), and such supplementary services include, for example, the insertion of Dual Tone Multiple Frequency (DTMF) tones, announcements and establishment of conference calls, as is known to a skilled person. In most cases, however, supplementary services are not added to connection data.

The base transceiver station (BTS) sends coded speech data received from the mobile terminal to the transcoding unit (TRAU) by way of an A-bis interface channel and the TRAU sends decoded speech data to the mobile switching centre (MSC) by way of an A-interface channel. As the skilled person will readily appreciate, the MSC is not aware of the TRAU. At connection set-up, a TRAU is automatically allocated.

As explained above, the mobile switching centre (MSC) routes the (speech) data to the connection (call) destination. When the connection is routed to an adjacent MSC, the data is output on an inter-MSC E-interface channel.

The A-bis interface channel data rate is variable, and depends on the data rate of the data received from the mobile terminal (MS). As is well known, a number of different data rates for the coded speech signal received from the mobile terminal (MS) have been specified in the GSM standard. However, the data rate is typically 16 kbps for full rate (FR)/enhanced full rate (EFR) coded speech or is 8 kbps for half rate (HR) coded speech.

In the GSM system as described above, the A interface data and the E interface data have a data rate of 64 kbps per channel. The transcoding unit (TRAU) is thus provided to transcode data between an A-bis interface channel (connected to the mobile terminal (MS) via the BTS) and an A-interface channel (connected to the MSC). In this context, transcoding means source encoding and decoding, for example speech encoding and decoding.

However, the transcoding between the, for example, 16 kbps coded data used for the speech data received at the transcoding unit (TRAU) on the A-bis interface channel and the decoded 64 kbps data used on the A interface and E interface channels in the switching network inevitably results in a degradation in speech quality owing to algorithmic principles and/or inaccuracies in the transcoding. This effect is particularly noticeable in mobile terminal (MS) to mobile terminal (MS) calls when the 16 kbps coded speech data received from the sending mobile terminal is first decoded into 64 kbps speech data for transmission over the telecommunications network and then encoded back to 16 kbps coded speech data for transmission over the air interface to the receiving mobile terminal (MS). In this case, the two transcoding units (TRAUs) are said to be operated in tandem mode.

“Tandem-free” operation (TFO) has been suggested to alleviate this problem. The use of tandem-free operation (TFO) for GSM speech data has become standardised and is outlined in ETSI specification GSM08.62.

The operation of a TFO-TRAU, i.e. a transcoding unit (TRAU) having TFO capabilities, will now be described. Firstly, it should be understood that the data on the 64 kbps A interface channel comprises groups of 8 bits sent every 125 microseconds. The TFO-TRAU fills two bits of each group of 8 bits with two bits taken from the coded data received from the mobile terminal via a 16 kbps A-bis interface channel. The TFO-TRAU also carries out the usual decoding of the incoming coded speech data and sends the resulting decoded speech data in the remaining 6 bits of each group of 8 bits. Thus, the TFO-TRAU transmits the original (coded) 16 kbps speech data [received from the mobile terminal via the BTS] together with 48 kbps of the same speech signal in a decoded form to the mobile switching centre (MSC).

At the call destination, when a TFO-TRAU receives TFO data from the mobile switching centre on an A interface channel, the TFO-TRAU performs, in a sense, the reverse operation to that described above, and outputs the 16 kbps coded speech data on an A-bis interface channel (while ignoring the decoded speech data contained in the TFO data).

Thus, it can be seen that the use of a TFO-TRAU allows the data rate of 64 kbps required on the A interface and the E interface of the mobile switching centre to be maintained while simultaneously enabling the 16 kbps original (coded) speech data to be transmitted without transcoding, thus maintaining the quality of the speech signal.

If a connection (call, e.g.) is to be received by a receiving mobile terminal, the use of TFO-TRAUs can ensure that the speech quality can be maintained since the original 16 kbps coded speech data is transmitted through the network unaltered (at least when supplementary services are not being added to the call). However, the TFO-TRAU close to the sending mobile terminal (MT) does not know whether or not the transcoding unit (TRAU) at the receiving end has TFO capabilitites, i.e. whether there is a TFO-TRAU or “just” a usual (non-TFO) TRAU close to the receiving mobile terminal.

Therefore, the 16 kbps speech data received from a sending mobile terminal is initially decoded by the TFO-TRAU in the normal (non-TFO) way to 64 kbps decoded speech data (i.e. without coded speech data) for transmission over the switching network. However, in order to determine whether tandem-free operation is possible, TFO parameter data is transmitted at intervals. If TFO parameter data is received back from the other TRAU, the call can be conducted using tandem-free operation, which maximises speech quality.

In this respect, it is important to note that all TFO signalling is accomplished in-band, and no extra out-of-band signalling between the sending and receiving TRAUs is required to establish a TFO connection.

The cost of providing capacity on the inter-MSC E-interface is a considerable proportion of the cost of operating the telecommunications network. As a result, it is desirable to reduce the data rate of signals sent between adjacent mobile switching centres (MSC) in order to minimise costs. It has therefore been suggested to insert a TFO-specific circuit multiplication equipment (TCME) between the mobile switching centres. The TCME comprises at least one pair of TCME-heads, as schematically illustrated in FIG. 3, each of which is located adjacent an associated MSC and includes a plurality of TCME units. When a TCME unit receives 64 kbps TFO data from the MSC on an E-interface channel, the TCME unit is able to eliminate the 48 kbps of decoded speech data (which is redundant) and forwards only the original 16 kbps coded speech data to the corresponding TCME-head at the adjacent MSC on a new 16 kbps interface subchannel (defined herein as an E-bis interface channel). Four 16 kbps E-bis interface subchannels are combined by the TCME-head resulting in the usual 64 kbps data rate for inter-MSC signals, as schematically illustrated in FIG. 3. The receiving TCME-head performs the reverse operations on receipt of data in a 16 kbps E-bis interface channel, and outputs 64 kbps TFO data on an E-interface channel to its MSC.

The use of TCME as outlined above allows up to 75% of the transmission costs in the inter-MSC network to be saved whilst maintaining tandem-free speech quality in mobile terminal (MS) to mobile terminal calls. For connections to other call destinations (PSTN, e.g.), i.e. in non-TFO mode, transmission costs in the inter-MSC network can only be saved at the expense of speech quality by introducing an additional transcoding step in the TCME heads. This, however, complicates TCME hardware. In summary, the introduction of TCME has the drawback that separate complex hardware (TCME heads) is required, with associated operation and maintenance costs.

Although in the description of connection (call) handling provided above only a single (or a pair of) transcoding unit(s) has been described, clearly, in reality, for each MSC a plurality of transcoding units (TRAUs) is provided (as generally illustrated in FIG. 3) together with a switch (not shown) and a transcoder controller (not shown) which allocates a TRAU to each connection and controls the switch to switch the connection data through the allocated TRAU. The plurality of transcoding units (TRAUs), switch and transcoder controller usually are located in the base station controller (BSC) as is known to a skilled person and as is illustrated in FIG. 3. However, it may be particularly advantageous to include the plurality of transcoding units (TRAUs), switch and transcoder controller in a transcoding apparatus separate from the BSC.

Similarly, a plurality of TCME units is provided together with a TCME head switch (not shown in FIG. 3) and a TCME head controller (not shown) which allocates a TCME unit to each connection and controls the TCME head switch to switch the connection data through the allocated TCME unit.

It is clear from the above description that a transcoding unit (TRAU) and a TCME unit are very similar in function and so it has been proposed in the applicant's previous United Kingdom Patent Application No. 9918953.2 that the transcoding units (TRAUs) and the TCME units associated with an MSC are co-located. In this proposal, the E-interface of the MSC is connected to TCME units co-located with the transcoding units (TRAUs). As a result of the co-location of the transcoding units (TRAUs) and the TCME units, the maintenance overhead and operating costs associated with the TCME can be reduced. However, in previous proposals, it has not been possible to reduce the hardware required for transcoding and/or circuit multiplication purposes. Herein, the required hardware can for example be measured in terms of the number of TRAUs and TCME units, respectively, and the complexity of associated switching and controlling units.

### SUMMARY OF THE INVENTION

In view of the above, it is therefore the object of the invention to reduce the hardware required for transcoding and/or circuit multiplication purposes whilst maintaining the primary benefits associated with tandem-free operation (TFO) and/or circuit multiplication. As explained above these primary benefits are the higher speech quality with mobile terminal to mobile terminal calls in case of TFO and the cost savings on the inter-MSC E interface in case of circuit multiplication. It is a further object of the invention to minimize the signalling effort required for the reduction in hardware. In particular, no network-wide routing information is to be used.

According to claim 1 there is provided a transcoding apparatus for use in a switching network (comprising at least one MSC with associated network nodes such as BSCs, BTSs and/or TCME heads) of a telecommunication system such as a mobile radio communication system, said transcoding apparatus including (a) a plurality of TRAUs for source encoding and decoding data, for example speech data, wherein at least one TRAU of said plurality is capable of operating in TFO mode (i.e. is a TFO-TRAU as defined above with respect to the prior art), (b) switching means adapted to switch data through said plurality of TRAUs, (c) a transcoder controller for controlling said switching means and said plurality of TRAUs, wherein said transcoder controller is adapted to (d) instruct said switching means to insert one of said at least one TRAU into a data path associated with a connection (call, e.g.) between a mobile terminal of said telecommunication system and said switching network, and wherein said transcoder controller is adapted to (e) instruct said one of said at least one TRAU to operate in TFO mode, and wherein said transcoder controller is adapted to (f) instruct, during said connection, said switching means to eliminate said one of said at least TRAU from said data path. In other words, the transcoder controller is able to take the actions necessary in order to remove the allocated TFO-TRAU from the data path associated with an established TFO-connection between a mobile terminal and, say, the MSC of said switching network (and, of course, further to the call destination). This allows for a TRAU-free operation of said connection. Considering the transcoding apparatus as a whole, the number of TRAUs in said plurality can thus be reduced resulting in a reduced hardware required for transcoding purposes.

Preferrably, according to claim 2, the transcoding apparatus further includes a plurality of TCME units for performing TFO-specific circuit multiplication operations, wherein said transcoder controller is adapted to instruct said switching means to insert one of said plurality of TCME units into said data path, and wherein said transcoder controller is adapted to instruct, during said connection, said switching means to eliminate said one of said plurality of TCME units from said data path. In other words, the transcoder controller is able to take the actions necessary in order to remove the allocated TCME unit from the data path associated with an established TFO-connection between a mobile terminal and, say, the MSC of said switching network (and, of course, further to the call destination). This allows for a TCME-free operation of said connection. Considering the transcoding apparatus as a whole, the number of TCME units in said plurality can thus be reduced resulting in a reduced hardware required for circuit multiplication purposes.

Advantageously, according to claims 3 and 5, the transcoder controller is adapted to determine (obtain knowledge about the question) whether or not (and when) a switching controller (in the MSC, e.g.) of said switching network intends to add (or is adding) supplementary services (as explained above with respect to the prior art) during said connection. It is further adapted to instruct, during said connection, said switching means to eliminate said one of said at least one TRAU and/or said one of said plurality of TCME units from said data path, if said switching controller does not intend to add (or is not adding) supplementary services. In other words, the transcoder controller is able to take the actions necessary in order to remove the allocated TRAU and/or the allocated TCME unit from the data path associated with said established TFO-connection, if (and whenever) the switching controller does not intend to add (or is not currently adding) supplementary services to said connection (or equivalently, if and whenever the switching controller of the MSC is transparently through-connecting the call). This allows for a TRAU-free and/or TCME-free operation of said connection during periods in which no supplementary services are added.

Preferrably, according to claims 7 to 11, the transcoder controller is adapted to determine, based on an evaluation of locally available information, whether or not a switching controller of said switching network intends to add supplementary services during said connection. Examples for such locally available information are (a) results of a supervision of inputs and outputs of said transcoding apparatus (claim 8), (b) results of a supervision of reports from said one of said at least one TRAU and/or from said one of said plurality of TCME units, i.e. from the allocated TRAU and/or the allocated TCME unit (claim 9), and (c) information received from said switching controller (claim 10) such as port address information (claim 11). The features of claims 7 to 11 thus advantageously allow for a minimization of the signalling effort required for the reduction in hardware, because only locally available information, i.e. information which is available (or can be derived) in the transcoding apparatus (and/or the TCME head) or the associated MSC, is used.

According to claim 14 there is provided a TCME head apparatus for use in a switching network (comprising at least one MSC with associated network nodes such as BSCs, BTSs and/or transcoding apparati) of a telecommunication system such as a mobile radio communication system, said TCME head apparatus including (a) a plurality of TCME units for performing TFO-specific circuit multiplication operations, (b) switching means adapted to switch data through said plurality of TCME unit's, and (c) a TCME head controller for controlling said switching means and said plurality of TCME units, wherein said TCME head controller is adapted to (d) instruct said switching means to insert one of said plurality of TCME units into a data path associated with a connection (call, e.g.) between a mobile terminal of said telecommunication system and said switching network, and wherein said TCME head controller is adapted to (e) instruct, during said connection, said switching means to eliminate said one of said plurality of TCME units from said data path. In other words, the TCME head controller is able to take the actions necessary in order to remove the allocated TCME unit from the data path associated with an established TFO-connection between a mobile terminal and, say, the MSC of said switching network (and, of course, further to the call destination). This allows for a TCME-free operation of said connection. Considering the TCME head apparatus as a whole, the number of TCME units in said plurality can thus be reduced resulting in a reduced hardware required for circuit multiplication purposes.

Advantageously, according to claim 15, the TCME head controller is adapted to determine (obtain knowledge about the question) whether or not (and when) a switching controller (in the MSC, e.g.) of said switching network intends to add (or is adding) supplementary services (as explained above with respect to the prior art) during said connection. It is further adapted to instruct, during said connection, said switching means to eliminate said one of said plurality of TCME units from said data path, if said switching controller does not intend to add (or is not adding) supplementary services. In other words, the TCME head controller is able to take the actions necessary in order to remove the allocated TCME unit from the data path associated with said established TFO-connection, if (and whenever) the switching controller does not intend to add (or is not currently adding) supplementary services to said connection (or equivalently, if and whenever the switching controller of the MSC is transparently through-connecting the call). This allows for a TCME-free operation of said connection during periods in which no supplementary services are added.

Preferrably, according to claim 17, the TCME head controller is adapted to determine, based on an evaluation of locally available information, whether or not a switching controller of said switching network intends to add supplementary services during said connection. Examples for such locally available information are (a) results of a supervision of inputs and outputs of said TCME head apparatus, (b) results of a supervision of reports from said one of said plurality of TCME units, i.e. from the allocated TCME unit, and (c) information received from said switching controller such as port address information. These features thus advantageously allow for a minimization of the signalling effort required for the reduction in hardware, because only locally available information, i.e. information which is available (or can be derived) in the TCME head apparatus or the associated MSC or transcoding apparatus, is used.

### BRIEF DESCRIPTION OF THE DRAWINGS

For a better understanding of the present invention, and to show how it may be brought into effect, reference will now be made, by way of example, to the accompanying drawings, in which

FIGS. 1A and 1B relate to a first arrangement in which TCME units are external to a transcoding apparatus TRC, wherein

FIG. 1A shows the data path associated with a connection before the TRAU and the TCME unit are eliminated therefrom, while

FIG. 1B shows said data path after elimination of the TRAU and the TCME unit therefrom according to the invention;

FIGS. 2A and 2B relate to a second arrangement in which TCME units are included in a transcoding apparatus TRC, wherein

FIG. 2A shows the data path associated with a connection before the TRAU and the TCME unit are eliminated therefrom, while

FIG. 2B shows said data path after elimination of the TRAU and the TCME unit therefrom according to the invention; and

FIG. 3 schematically illustrates the structure of a GSM mobile communications system.

### DETAILED DESCRIPTION OF THE INVENTION

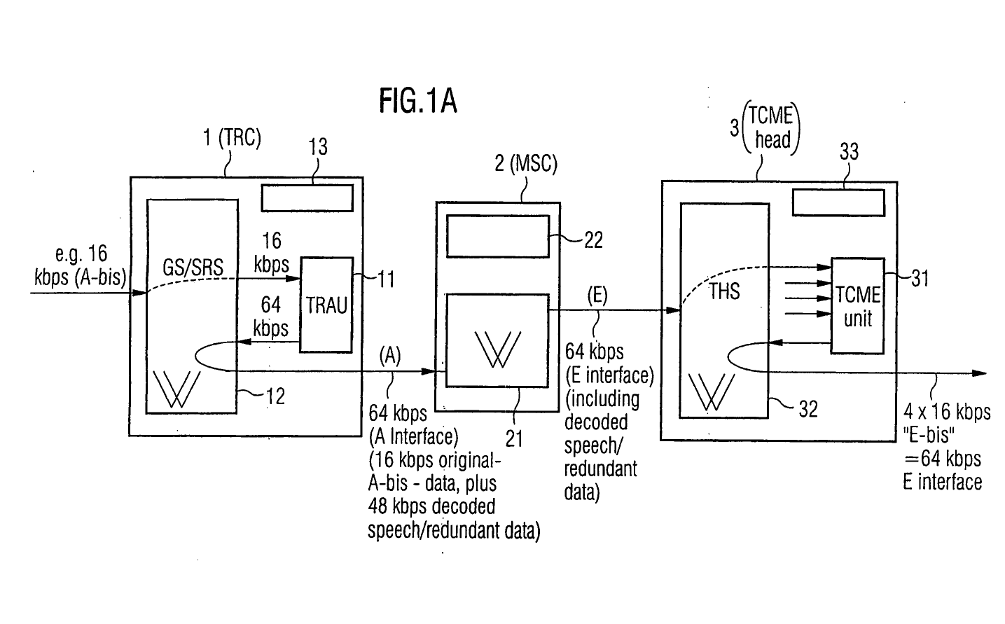

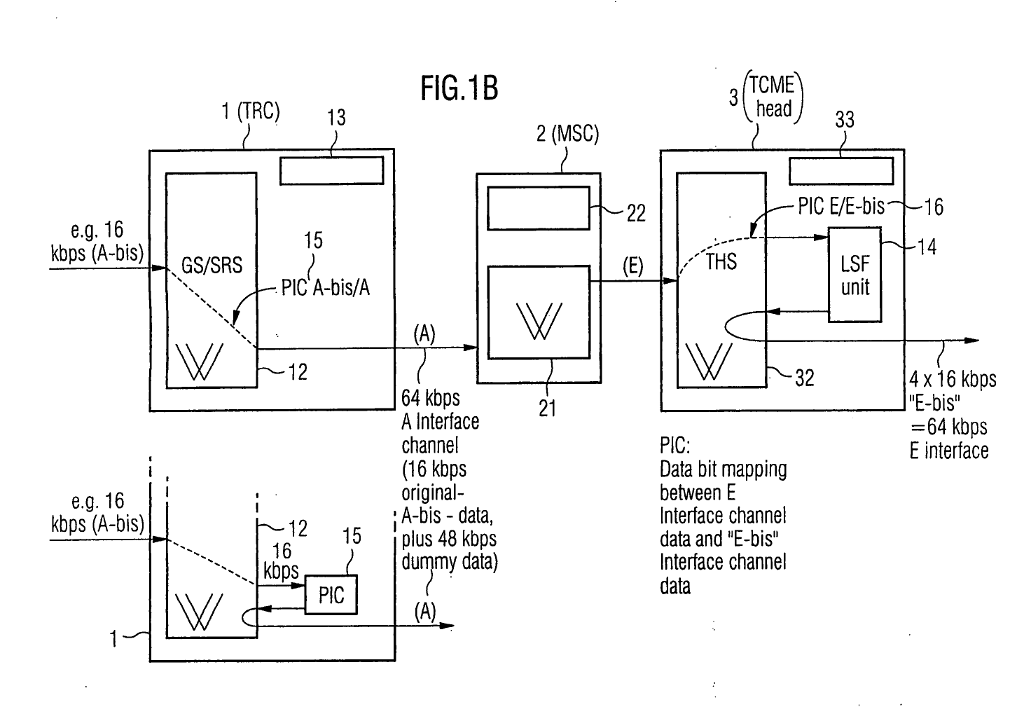

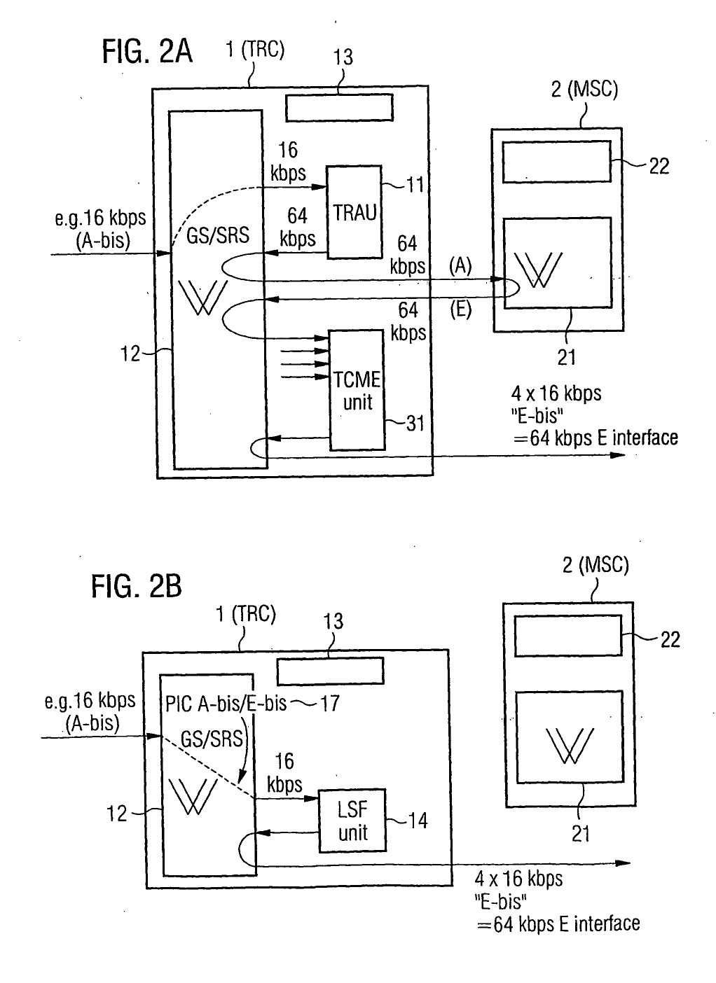

Two embodiments of the invention will now be described with reference to FIGS. 1 and 2.

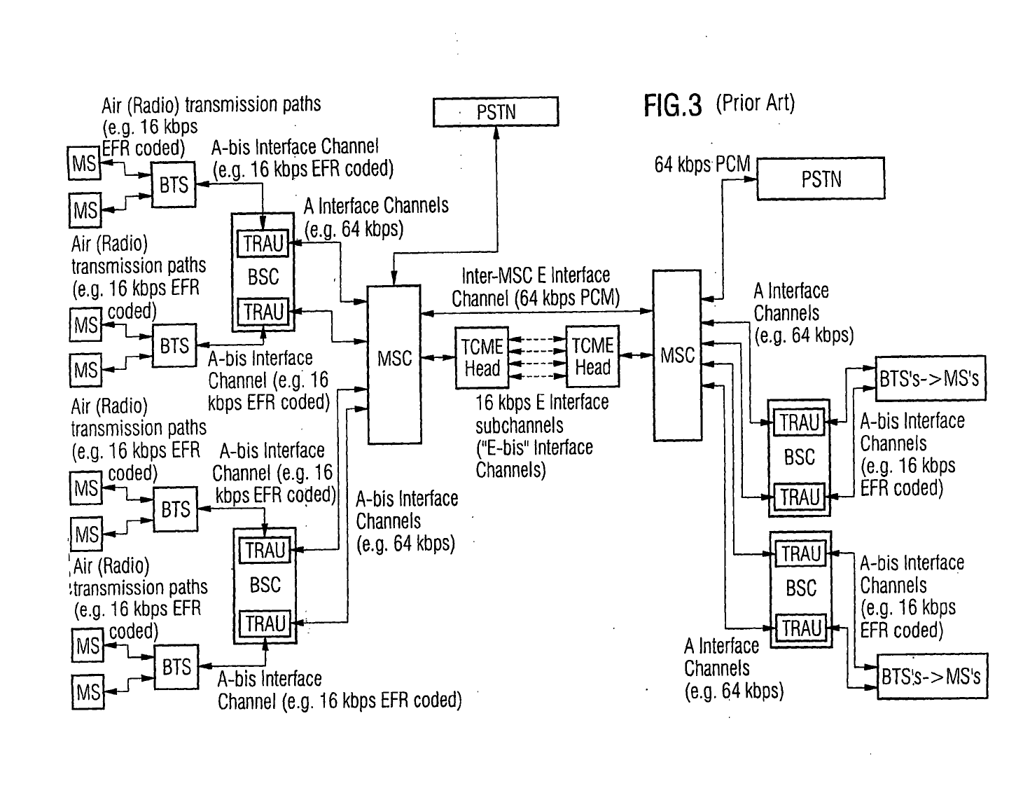

FIGS. 1A and 1B relate to a first arrangement wherein the transcoding units (TRAUs) and the TCME units are included in separate apparati/devices which may or may not (cf. FIG. 3) be co-located at the same site (also referred to as “co-sited”). As can be seen from FIG. 1A, in this arrangement, a transcoding apparatus (TRC) 1 is provided with a plurality of transcoding units (TRAUs) 11, a group/sub-rate switch (GS/SRS) 12 and a transcoder controller 13 for controlling the operation of the transcoding units (TRAUs) 11 and the group/sub-rate switch 12. Via an A interface, the transcoding apparatus (TRC) 1 is coupled to a mobile switching centre (MSC) 2, which has a group switch 21 and a switching controller 22 for controlling the operation of the group switch 21. Via an E interface, the MSC 2 is coupled to an associated TCME-head 3 equipped with a plurality of TCME units 31. Similar to the transcoding apparatus (TRC) 1 of FIG. 1A, the TCME head 3 further includes a TCME head switch (THS) 32 and a TCME head controller (33) for controlliong the operations of said TCME head switch (THS) 32 and said plurality of TCME units 31.

FIGS. 2A and 2B relate to a second arrangement wherein the components of the transcoding apparatus 1 of FIG. 1A and the components of the TCME head 3 of FIG. 1A, i.e. in particular said plurality of transcoding units (TRAUs) 11 and said plurality of TCME units 31, are included (integrated) in a single apparatus or device. As can be seen from FIG. 2A, the transcoding apparatus (TRC) 1 in the second arrangement includes said pluralities of TRAUs 11 and TCME units 31 as well as a group/sub-rate switch (GS/SRS) 12 and a transcoder controller 13. It is to be noted here that instead of having separate switches for the TRAUs and for the TCME units and instead of having separate controllers for controlling the operation of the TRAUs and their associated switch on the one hand, and for controlling the operation of the TCME units and their associated switch on the other hand, it is assumed in FIG. 2A that the transcoding apparatus (TRC) 1 in the second arrangement only includes one combined (enlarged, with respect to the first arrangement) group/sub-rate switch (GS/SRS) 12 and one combined transcoder controller 13 for controlling the operations of the pluralities of TRAUs 11 and TCME units 31, and the (combined) group/sub-rate switch 12. Otherwise, the same reference numerals are used herein to denote blocks having the same or a similar functionality.

FIG. 1A shows a situation wherein the switching controller 22 of the MSC 2 is not adding supplementary services to the connection (call, e.g.) data, and TFO mode is adopted in a conventional manner, as described above with respect to the prior art.

The coded speech data from the base transceiver station (BTS) is received by the transcoding apparatus (TRC) 1 on an A-bis interface channel at 8 or 16 kbps. The transcoder controller 13 allocates one of the plurality of transcoding units (TRAUS) 11 to the received signal and controls the group/sub-rate switch 12 to switch the incoming A-bis interface signal to the allocated TRAU 11, as indicated in FIG. 1A by a dashed line. Assuming that both the allocated TRAU 11 and the TRAU at the call destination are TFO-TRAUs as defined above with respect to the prior art, the allocated TRAU 11 transcodes the data using tandem-free operation (TFO) mode and, in TFO frames according to GSMO8.62, outputs 64 kbps data comprising 16 kbps coded speech data corresponding to the original (coded) data, in addition to 48 kbps of decoded speech data or pre-defined dummy data.

The 64 kbps A-interface channel data output from the allocated TRAU 11 is input to the MSC 2 (via the switch 12). The switching controller 22 routes the connection through the group switch 21 of the MSC 2.

The output of the group switch 21 is then forwarded to the TCME-head 3, wherein the TCME head controller 33 controls the TCME head switch (THS) 32 to switch the incoming E interface signal to the allocated TCME unit 31, as indicated in FIG. 1A by the dashed line. The allocated TCME unit 31 performs a reverse operation to that performed by the allocated TRAU 11, in the sense that the allocated TCME unit 31 deletes the 48 kbps decoded speech or dummy data added by the allocated TRAU 11, and (via the switch 32) outputs the 16 kbps original (coded) speech data to another TCME head associated with an adjacent MSC on a 16 kbps E interface subchannel (which may be termed an “E-bis” interface channel), or equivalently outputs four combined 16 kbps “E-bis” interface channels on a single 64 kbps E-interface channel, as indicated in FIG. 1A. As the skilled person will readily appreciate, said combining of four 16 kbps “E-bis” interface channels into a single 64 kbps E interface channel could also be achieved by the TCME head switch (THS) 32 of the TCME head 3.

FIG. 2A also shows the situation described above with respect to FIG. 1A wherein the switching controller 22 of the MSC 2 is not adding supplementary services to the connection (call, e.g.) data, and TFO mode is adopted in a conventional manner, as described above with respect to the prior art. Apart from the fact that, as described above, the group/subrate switch 12 in FIG. 2A combines the two switches 12 and 32 of FIG. 1A (and the transcoder controller 13 in FIG. 2A combines the controllers 13 and 33 of FIG. 1A), the data flow shown in FIG. 2A is in substance the same as described above with respect to FIG. 1A and so will not be described further.

In accordance with the invention, however, in both arrangements, the transcoder controller 13 is informed that the switching controller 22 is transparently connecting the connection (call, e.g.) through the group switch 21 and then operates to eliminate the allocated TRAU 11 and/or the allocated TCME unit 31 from the data path of the connection. The transcoder controller 13 may receive the information from the switching controller 22 itself, or may derive this knowledge from other sources such as may be provided by (a) supervision of the inputs and outputs of the transcoding apparatus 1—either 64 kbps inputs and outputs or 16 kbps inputs and outputs—in order to identify identical input and output channels, which would indicate a transparent mode of operation of the MSC 2 for the channel concerned, for example using correlation techniques, or (b) supervision of reports from the TRAU and/or the TCME unit, indicating when they achieve or abandon TFO mode, for example. Technique (a) can be effected internally of the transcoding apparatus 1 whether the TRAUs and the TCME units are co-located/integrated or not, whilst technique (b) can be effected internally of the transcoding apparatus 1 only if the TRAUs and TCME units are co-located/integrated. Within the scope of the invention, any suitable technique for detecting transparent operation may be employed. In such “transparent connection” situations it is not necessary for the speech data received on the A-bis channel to be transcoded, and therefore the allocated TRAU 11 and the allocated TCME unit 31 shown in FIGS. 1A and 2A can be effectively eliminated from the data path of the connection.

FIG. 1B shows the data flow through the first arrangement, again in a situation wherein the switching controller 22 of the MSC 2 is not adding supplementary services and thus is transparently through-connecting the connection (call, e.g.) data.

In accordance with the invention, as described above, the transcoder controller 13 is informed (or otherwise obtains knowledge about the fact) that the switching controller 22 is transparently through-connecting the call through the group switch 21. Based on this information, the transcoder controller 13 then eliminates the transcoding unit (TRAU) allocated to that connection from the data path, and instead controls the group/sub-rate switch 12 so that the 16 kbps A-bis interface channel data is converted (mapped) into a 64 kbps A interface channel data stream consisting of the 16 kbps of the original (coded) data as TFO parameters and 48 kbps of redundant data. This redundant data is not transcoded speech data but is instead merely “dummy” data added to ensure the correct data rate on the A interface channels and the E interface channels. As the skilled person will readily appreciate, instead of controlling the group/sub-rate switch 12 so as to perform said A-bis/A protocol/interface conversion (PIC) 15, the transcoder controller 13 can also control a separate PIC unit 15, as shown in the bottom part of FIG. 1B, to perform this simple conversion (basically relating to a rearrangement of bits while adding said dummy data) from/to the protocol on the A-bis interface to/from the TFO protocol on the A interface.

The resulting 64 kbps A interface channel data is output to the mobile switching centre 2 and is transparently connected through the group switch 21 and output to the TCME head 3 via a 64 kbps E-interface channel.

Similar to the operation of the transcoder controller 13, the TCME head controller 33 eliminates the allocated TCME unit 31 from the data path and instead controls the TCME head switch (THS) 32 so that the 64 kbps E interface channel data is converted (mapped) into a 16 kbps “E-bis” interface channel (E interface subchannel) data stream only consisting of the 16 kbps of the original (coded) data as TFO parameters (while the 48 kbps redundant dummy data, inserted by the A-bis/A PIC 15 in the transcoding apparatus (TRC) 1, is removed). Instead of controlling the TCME head switch (THS) 32 so as to perform said E/E-bis protocol/interface conversion (PIC) 16, the TCME head controller 33 can also control a separate PIC unit 16 (or the LSF unit 14 described below) to perform this simple conversion (basically relating to a rearrangement of bits while removing said dummy data) from/to the TFO protocol on the E interface to/from the TFO protocol on the E-bis interface.

The resulting “E-bis” interface channel data is then forwarded to a link supervision function (LSF) unit 14 which monitors the TFO protocol and notifies the TCME head controller in case of a loss (non-detection) of the TFO protocol so that it can take the actions necessary to leave TFO mode.

As the skilled person will readily appreciate, at least one LSF unit 14 is necessary in the TCME head 3 and/or the transcoding apparatus (TRC) 1. In any case, each LSF unit 14 notifies its associated controller (13, 33) in case of a loss of the TFO protocol, i.e. when the TFO protocol can no longer be detected. Also, the LSF unit 14 can take over the corresponding PIC function (i.e. the A-bis/A PIC 15 if the LSF unit 14 is part of the transcoding apparatus (TRC) 1 and/or the E/E-bis PIC 16 if the LSF unit 14 is part of the TCME head 3).

Finally, the LSF unit 14 outputs the 16 kbps original (coded) speech data to another TCME head associated with an adjacent MSC on a 16 kbps E interface subchannel (“E-bis” interface channel), or equivalently outputs four combined 16 kbps “E-bis” interface channels on a single 64 kbps E-interface channel. As the skilled person will readily appreciate, said combining of four 16 kbps “E-bis” interface channels into a single 64 kbps E-interface channel can also be achieved by the TCME head switch (THS) 32 or said PIC unit 16 of the TCME head 3.

The PIC units 15 and 16 as well as the LSF unit(s) 14 are thus, in comparison with TCME units and TRAUs, simple hardware components (if necessary at all in case of the PIC units, as described above). Thus, with this embodiment of the present invention, when a transparent connection is established, the allocated TRAU and/or the allocated TCME unit can be eliminated from the data path of the connection, with savings in that the speech transcoders in the TRAU and/or the TCME unit are not needed, thereby providing for significant power saving in relation to digital speech processing (DSP) functions. Overall, the present invention allows the number of TRAUs and TCME units in the communications system to be reduced, to be replaced by simple LSF and PIC units (14, 15, 16), thus offering considerable cost savings.

As the skilled person will readily appreciate, a synchroneous (simultaneous) elimination of the allocated TRAU 11 and the allocated TCME unit 31 will in general be possible only if the transcoding apparatus (TRC) 1 and the TCME head 3 are co-located (cf. FIG. 1B) or their components are integrated into a single device or apparatus (see FIG. 2B). In these cases, a single LSF unit 14 is sufficient, as will be seen from the following description of FIG. 2B.

FIG. 2B shows the data flow through the second arrangement, again in a situation wherein the switching controller 22 of the MSC 2 is not adding supplementary services and thus is transparently through-connecting the connection (call, e.g.) data.

Again, in accordance with the invention, as described above, the transcoder controller 13 is informed (or otherwise obtains knowledge about the fact) that the switching controller 22 is transparently through-connecting the call through the group switch 21. Based on this information, the transcoder controller 13 eliminates the allocated TRAU 11 and the allocated TCME unit 31 associated to that connection from the data path. Instead, the transcoder controller 13 controls the group/sub-rate switch 12 so that the 16 kbps A-bis interface channel data is directly converted (mapped) to an E-bis interface channel (16 kbps E interface subchannel) data stream consisting of the original (coded) data as TFO parameters. As the skilled person will readily appreciate, instead of controlling the group/sub-rate switch 12 so as to perform said A-bis/E-bis protocol/interface conversion (PIC) 17, the transcoder controller 13 can also control a separate PIC unit 17, or alternatively, the LSF unit 14 as described below, to perform this simple conversion (basically relating to a rearrangement of bits) from/to the protocol on the A-bis interface to/from the TFO protocol on the E-bis interface.

Instead of TRAU/TCME operations, a link supervision function (LSF) is effected by the LSF unit 14. As described above with respect to FIG. 1B, the LSF unit 14 monitors the TFO protocol and notifies the transcoder controller 13 in case the TFO protocol is lost (i.e. can no longer be detected).

Thus, the same advantages can be obtained with this arrangement as are explained above with reference to the FIG. 1B arrangement.

Of course, it is possible for the group/subrate switch 12 shown in FIG. 2B (or the separate PIC unit 17) to map the A-bis interface channel data to 64 kbps data by adding redundant data (this would correspond to the A-bis/A PIC 15 as described above with respect to FIG. 1B) and for the LSF unit 14 (or a further separate PIC unit) to re-map the 64 kbps data to the E-bis interface channel (this would correspond to the E/E-bis PIC as described above with respect to FIG. 1B), as outlined above with respect to FIG. 1B.

Thus, in accordance with the invention, it is possible to realise TRAU-free and/or TCME-free operation for mobile terminal (MT) to mobile terminal connections in a particularly simple manner and without using out-of-band signalling.

The elimination of the allocated TRAU 11 and/or the allocated TCME unit 31 can be accomplished locally on the basis of information provided by the switching controller 22 of the local MSC 2, or provided by other sources as indicated above, and no network-wide routing information or any other non-local information is necessary. The MSC functionality remains unchanged.

The switching controller 22 of the mobile switching centre 2 retains control of the routing of the connection. If, while a call (connection) is in progress, it is necessary for the MSC to alter the routing of the connection (e.g. due to a hand-over action or the establishment of a conference call) or to insert supplementary services, the switching controller 22 of the MSC 2 can inform the transcoder controller 13 and/or the TCME head controller 33 of the alteration.

The invention has been described with reference to the GSM system. However, it is clear that the invention is not restricted to such a system and can be applied to other telecommunications systems, in-particular to other second generation mobile telecommunication systems.

Clearly the E-bis interface can be based also on ATM, ATM-AAL2 or IP traffic. In this case, a further protocol/interface conversion (PIC) must be performed toward the desired protocol. However, both PIC and LSF are relatively simple functions compared to the complexity of TRAU or TCME operations.

Furthermore, embodiments of the present invention have been described with reference to speech data. However, it will be understood that the invention can also be applied to any other kind of data, such as fax, modem or computer data, as long as said data undergoes some kind of source coding/decoding, i.e. transcoding. 0.0

List of Abbreviations:

AAL2: ATM adaption layer 2
ATM: Asynchronous transfer mode
BSC: Base station controller
BTS: Base transceiver station
EFR: Enhanced full rate
ETSI: European telecomm. standardisation institute
FR: Full rate
GS/SRS: Group switch/sub-rate switch
GSM: Global system for mobile communications
HR: Half rate
IP: Internet protocol
LSF: Link supervision function
MS: Mobile station/terminal
MSC: Mobile switching centre
PCM: Pulse code modulation
PIC: Protocol/interface conversion
PSTN: Public switched telephone network
TCME: TFO-specific circuit multiplication equipment
TFO: Tandem-free operation
THS: TCME head switch
TRAU: Transcoding unit
TRC: Transcoding apparatus

1. (currently amended) a transcoding apparatus for use in a switching network of a telecommunication system, said transcoding apparatus including:
a plurality of transcoding units for source encoding and decoding data, for example speech data, wherein at least one transcoding unit of said plurality is capable of operating in tandem-free operation mode,
switching means adapted to switch data through said plurality of transcoding units,
a transcoder controller for controlling said switching means and said plurality of transcoding units,
wherein said transcoder controller is adapted to instruct said switching means to insert one of said at least one transcoding unit into a data path associated with a connection between a mobile terminal of said telecommunication system and said switching network, and
wherein said transcoder controller is adapted to instruct said one of said at least one transcoding unit to operate in tandem-free operation mode wherein characterised in that
said transcoder controller is adapted to instruct, during said connection, said switching means to eliminate said one of said at least one transcoding unit from said data path.

2. The transcoding apparatus according to claim 1, further including:
a plurality of TCME units for performing TFO-specific circuit multiplication operations
wherein said transcoder controller is adapted to instruct said switching means to insert one of said plurality of TCME units into said data path, and
wherein said transcoder controller is adapted to instruct, during said connection, said switching means to eliminate said one of said plurality of TCME units from said data path.

3. The transcoding apparatus according to claim 1,
wherein said transcoder controller is adapted to determine whether or not a switching controller of said switching network intends to add supplementary services during said connection, and
wherein said transcoder controller is adapted to instruct, during said connection, said switching means to eliminate said one of said at least one transcoding unit from said data path, if said switching controller does not intend to add supplementary services.

4. The transcoding apparatus according to claim 3, wherein said transcoder controller is adapted to instruct, during said connection, said switching means to insert one of said plurality of transcoding units into said data path, if said switching controller intends to add supplementary services.

5. The transcoding apparatus according to claim 2,
wherein said transcoder controller is adapted to determine whether or not a switching controller of said switching network intends to add supplementary services during said connection, and
wherein said transcoder controller is adapted to instruct, during said connection, said switching means to eliminate said one of said at least one transcoding unit as well as said one of said plurality of TCME units from said data path, if said switching controller does not intend to add supplementary services.

6. The transcoding apparatus according to claim 5, wherein said transcoder controller is adapted to instruct, during said connection, said switching means to insert one of said plurality of transcoding units as well as one of said plurality of TCME units into said data path, if said switching controller intends to add supplementary services.

7. The transcoding apparatus according to claim 6, wherein said transcoder controller is adapted to determine, based on an evaluation of locally available information, whether or not a switching controller of said switching network intends to add supplementary services during said connection.

8. The transcoding apparatus according to claim 7, wherein said locally available information includes results of a supervision of inputs and outputs of said transcoding apparatus.

9. The transcoding apparatus according to claim 7, wherein said locally available information includes results of a supervision of reports from said one of said at least one transcoding units and/or from said one of said plurality of TCME units.

10. The transcoding apparatus according to claim 7, wherein said locally available information includes information received from said switching controller.

11. The transcoding apparatus according to claim 10, wherein said information received from said switching controller includes port address information.

12. The transcoding apparatus according to claim 11, further including at least one protocol/interface conversion unit for performing protocol conversion operations between different interfaces, wherein said transcoder controller is adapted to instruct, during said connection, said switching means to insert one of said at least one protocol/interface conversion unit into said data path.

13. The transcoding apparatus according to claim 12, further including at least one link supervision function unit for monitoring the TFO protocol wherein said transcoder controller is adapted to instruct, during said connection, said switching means to insert one of said at least one link supervision function unit into said data path.

14. A TCME head apparatus for use in a switching network of a telecommunication system, said TCME head apparatus including:
a plurality of TCME units for performing TFO-specific circuit multiplication operations
switching means adapted to switch data through said plurality of TCME units,
a TCME head controller for controlling said switching means and said plurality of TCME units,
wherein said TCME head controller is adapted to instruct said switching means to insert one of said plurality of TCME units into a data path associated with a connection between a mobile terminal of said telecommunication system and said switching network, wherein
said TCME head controller is adapted to instruct, during said connection, said switching means to eliminate said one of said plurality of TCME units from said data path.

15. The TCME head apparatus according to claim 14,
wherein said TCME head controller is adapted to determine whether or not a switching controller of said switching network intends to add supplementary services during said connection, and
wherein said TCME head controller is adapted to instruct, during said connection, said switching means to eliminate said one of said plurality of TCME units from said data path, if said switching controller does not intend to add supplementary services.

16. The TCME head apparatus according to claim 15, wherein said TCME head controller is adapted to instruct, during said connection, said switching means to insert one of said plurality of TCME units into said data path, if said switching controller intends to add supplementary services.

17. The TCME head apparatus according to to claim 16, wherein said TCME head controller is adapted to determine, based on an evaluation of locally available information, whether or not a switching controller of said switching network intends to add supplementary services during said connection.
